(19) United States
(12) Patent Application Publication
(10) Pub. No.: US 2006/0108078 A1
(43) Pub. Date: May 25, 2006

(54) Telescoping container for venetian blinds

(76) Inventors: Michael Kollman, Madison, WI (US); Adam Ward, Madison, WI (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/993,658

(22) Filed: Nov. 19, 2004

(51) Int. Cl. E06B 9/38

(52) U.S. Cl. 160/178.1 R

(57) ABSTRACT

A clear tubular container consisting of two sections, one slightly smaller than the other, that can telescope to a smaller size. A flexible tab locking mechanism prevents the tubular structure from increasing in length beyond its original size but allows the structure to easily telescope to a smaller size. Removable caps are mounted at each end. The caps can be removed and the container telescoped to a smaller size to allow the window blinds to be trimmed without removing them from the container. The container's length can be easily varied by changing the placement of the tab and window.

### FIELD OF THE INVENTION

The invention relates to a container for storing and trimming window blinds in which the blind can be trimmed to a desired length without removing the blind from the container.

### BACKGROUND OF THE INVENTION

Window blinds are an attractive and popular window covering used by many for both residential and commercial purposes. Horizontal, or venetian blinds consist of numerous slats hung on ladders that extend between a headrail and a bottomrail. These blinds can be custom made by the blind manufacturer or fabricator. Alternatively, the blinds can be sold through home centers and other retail outlets that buy the blinds in standard sizes and then trim the blinds as necessary to fit the windows of their customers. These stock blinds are individually packaged in boxes and shipped to retail outlets.

Once in the retail outlets customers can choose the type of blind they prefer. If the measurements of the window on which the blinds will be hung do not correspond to a stock size, a stock blind that is larger than the window is selected removed from its box and trimmed. Removing the blind from its packaging and then replacing the blind after trimming is time consuming for the retailer. Because of the numerous slats and the flexible nature of the blinds they can be awkward to work with and can be damaged during the trimming and repackaging process.

U.S. Pat. No. 6,793,073 to Tu discloses a window blind container formed by a rectangular box with removable ends. After the ends are removed, portions of the blind are exposed and can be trimmed without removing the blind from the box. The container disclosed by Tu remains the same size. Consequently, these containers must be manufactured in several sizes to accommodate different stock sizes of blinds. The size of the removable ends determines the amount of blind that is exposed upon their removal, which controls how much the blind can be cut down. After trimming, a remaining a portion of the blind will be exposed and the end must be placed over that exposed portion.

U.S. Pat. No. 3,521,810 to Boyer describes a rectangular telescoping box to hold elongated articles. The Boyer container has inner and outer sections with slits on the sides of the sections. Overlapping segments on each section between two slits can be forced inward to lock the sections together. Once the slits are engaged the box is locked into that particular length and cannot telescope to a larger or a smaller size. U.S. Pat. No. 4,380,290 to Luebke also describes a two-section container that locks into place with the use of an adjustable strap. Once locked, this container cannot be adjusted after the strap is secured. U.S. Pat. No. 4,392,605 to Backman and U.S. Pat. No. 4,483,095 to Webinger also describe telescoping containers that lock together, but the size of the container cannot be adjusted after locking.

There is a need for a telescoping container for venetian type blinds which allows a blind to be trimmed without removing the blind from the container. Preferably, a single telescoping container could be used for more than one stock blind size. Such a single container should have the ability to be easily altered to tightly hold any of several different stock blind sizes. The container should be made of a clear plastic so that the retailer and the buyer can easily view the blind that is inside the container without removing the blind from the package. Finally, the container should enable the blind to be cut down without removing the blind from the box.

### SUMMARY OF THE INVENTION

We provide a telescoping container to hold a venetian blind that can be used to carry and store the blind, and then trim the blind to a desired length without removing them from the container.

The container has two tubular sections. At least one section has a flexible tab that is pushed toward the other section and engages an opening in the other section when aligned with the opening. This engagement prevents the sections from telescoping to a larger size, but still allows the container to be made smaller. An end cap is provided on each section. The end cap could be configured so that the same end cap will fit on the end of each section.

Preferably, both sections have U-shaped cuts along their length which allows the portion of that section surrounded by each cut to be pushed inward to form a tab, as well as to provide an opening. This construction permits the tab on the outer section to slip into an opening in the inner section when the tab and opening are aligned.

The location of the flexible tabs on the telescoping sections determines the length to which the container can extend. Therefore, the container can be manufactured in one length and the size can be varied by the placement of the flexible tabs. Or there can be a multitude of flexible tabs on the sections in different locations to enable the container to extend to a selected one of several different lengths according to which tabs are pushed inward.

Preferably the container is constructed from a clear polycarbonate plastic so that the blind within the container can be easily viewed without removal from the container. The container can have a round, rectangular, square, triangular or other polygon cross-section and can be sized to fit a particular style of venetian blinds.

We also prefer to construct at least one of the end caps to have a cavity. The cavity can then be used to store hold down brackets or other hardware for the blind.

One can trim a venetian blind in the container here disclosed without removing the blind from the container. Removing the end caps and constricting the container to a smaller length expose the ends of the blind. The blind is trimmed on one exposed end and then trimmed on the other exposed end. After trimming is complete the container can be telescoped to a larger size to envelop the blinds and the end caps can then be replaced. The cut down blind can then be stored, delivered or carried away in its original container. The tab arrangement prevents the container from being expanded beyond its original size and does not allow the sections to be separated.

Other objects and advantages of the present container will become apparent from certain present preferred embodiments thereof that are shown in the drawings.

### BRIEF DESCRIPTION OF THE DRAWINGS

FIG. 1 is a perspective view of the present preferred embodiment of our telescoping container for venetian-type blinds in a fully extended position.

FIG. 2 is a sectional view taken along the line II-II in FIG. 1.

FIG. 3 is a sectional view similar to FIG. 2 showing the tubular sections partially inserted with the tabs not engaged.

FIG. 4 is a sectional view similar to FIG. 2 showing the flexible tab of one section interlocking with a window in the other section.

FIG. 5 is a perspective view of the second preferred embodiment before the sections are assembled.

FIG. 6 is a perspective view of the second present preferred embodiment containing a blind, after one end cap has been removed and collapsed to a smaller size exposing one end of the blind for trimming.

FIG. 7 is a perspective view of a present preferred end cap.

### DETAILED DESCRIPTION OF THE PREFERRED EMBODIMENTS

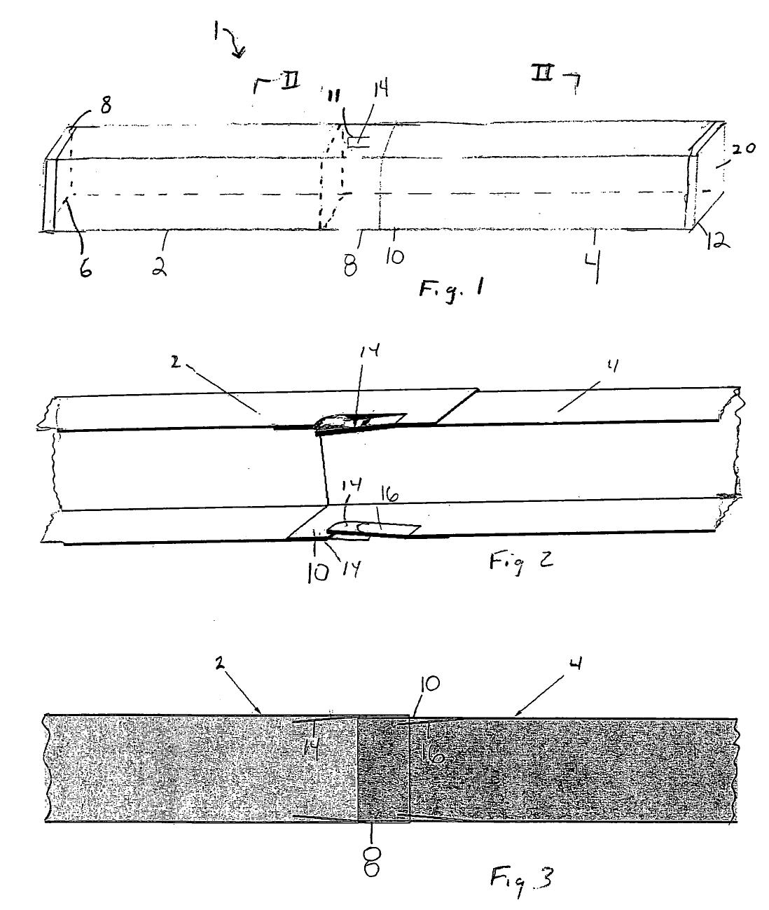

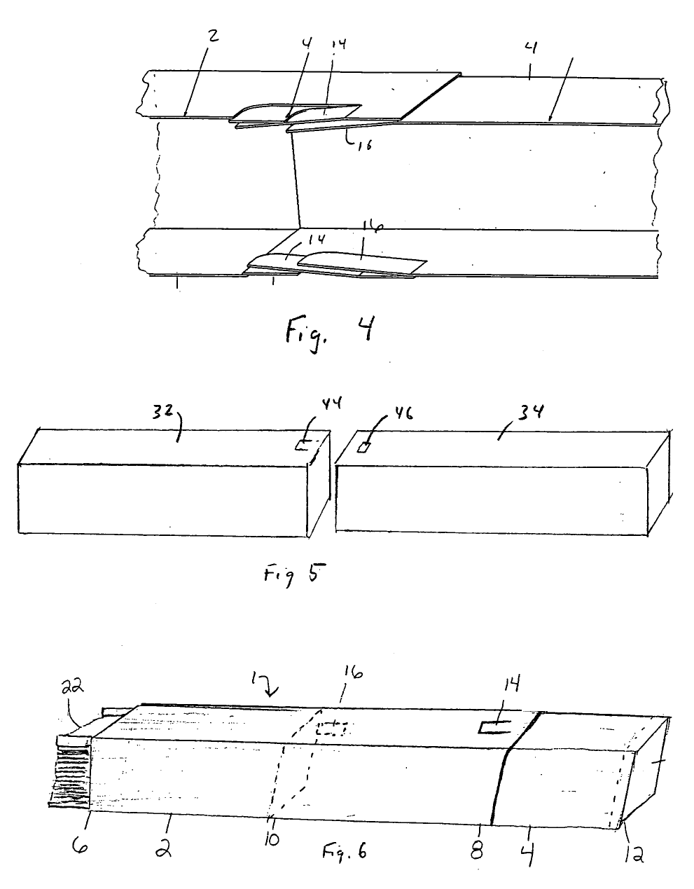

We provide a packaging system or container 1 having two tubular sections 2 and 4 which telescope together. In the first present preferred embodiment shown in FIGS. 1 through 4 the inner tubular section 4 fits into the outer section 2. A U-shaped cut 11 is made in both the tubular sections 2, 4. The segment of each section formed by the cut 11 is pushed inward to create a flexible tab 14, 16. When the inner section 4 is pushed into the outer section 2 the flexible tab 14 of the outer section 2 flexes up to allow the inner tubular section 4 to pass. The tab 14 is positioned to be aligned with the opening formed by tab 16 of the inner section. Being so aligned tab 14 will slip into that opening when the sections are pulled in opposite directions. When that occurs the locking arrangement shown in FIG. 2 exists and sections 2 and 4 cannot be extended further. In the preferred embodiments the tab extends inward. However, one could construct the tabs to extend outward so that a tab of the inner tubular section 4 will engage an opening in the outer tubular section 2. The tubular sections 2, 4 could have a cross-sectional shape of any multitude of designs, including, but not limited to rectangular, square, circular, oval or triangular. Preferably the container is constructed of a clear polycarbonate plastic so the blind contained within can be easily viewed. However, cardboard or stiff millboard could be used. The preferred tab is elongated and rounded at its distal end as shown in the drawings. But, other configurations could be used.

An end cap 18, 20 is provided on each section. In a present preferred embodiment of the container the diameter of the outer sleeve is only slightly larger than the diameter of the inner sleeve. Therefore, one end cap could be used on either end and held in place by tape or a tab lock. One embodiment of an end cap is shown in FIG. 7. That end cap 16 has two sections, 17 and 18. Section 17 has a diameter larger than the diameter of the end of outer section 4. The second section 18 has a diameter that is slightly smaller than the opening of the outer sleeve. Consequently, section 18 can be inserted into the open end of either sleeve. The end caps can be held in place with tape, a locking tab arrangement, a friction fit or other mechanism known in the art. In the event that the diameter of the inner sleeve is significantly less than the diameter of the outer sleeve, the end cap may have a third section 19 shown in dotted line. Section 19 has a diameter that is slightly smaller than the opening in the inner sleeve. The end cap is pushed onto an open end 6, 12 of either the tubular section 2, 4. Only the minor diameter portion 19 fits into the smaller sleeve 4 while both portions 18 and 19 fit into the outer sleeve 2. Another alternative is to construct the open end of the larger section to have the same size opening as the inner section. This can be done by providing an inner collar on the outer sleeve 2 adjacent the open end of that sleeve.

The position and configuration of tabs 14, 16 enable the container 1 to be easily made smaller, but the container can not grow beyond its original size. Moreover, the sleeves or sections 2, 4 cannot separate during normal use. One could however, move the inner sleeve 4 in an opposite direction, by pushing sleeve 4 from right to left in FIG. 1, completely through the outer sleeve 2 to separate them. By changing the position of the flexible tabs 14, 16 on the sections 2, 4, the maximum length of the telescoping container can be changed. One could make the container in one size that will accommodate and securely hold any of several different stock sizes of blinds. This can be accomplished by providing a series of available tabs 14, 16 in either or both of the telescoping sections 2, 4. Several U-shaped cuts can be provided along the length of one or both sections. However, only one segment defined by these cuts is pressed inward on each sleeve. By selecting different combinations of tabs on the sleeves one can vary the maximum extendable length of the container. This results in a container that can be easily manufactured and adapted to securely hold any one of several different size blinds.

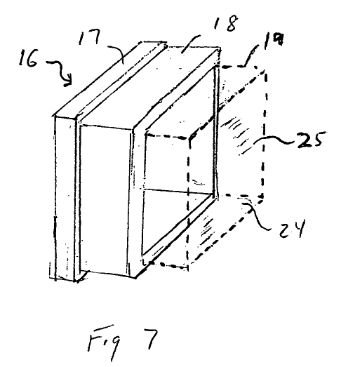

A second present preferred embodiment of the invention shown in FIGS. 5 and 6 has outer section 32 and inner section 34. In this embodiment there is an open window 46 rather than the flexible tab 16 in the inner tube 34. That window will receive the flexible tab 44 of the outer section 32 and lock the two sections in place. The two sections can be pulled in opposite directions until the flexible tab 44 extends into the window 46 locking the sections in place and preventing them from separating. Yet, one can still push the sections together allowing the sections to telescope to a smaller size. This embodiment is also simple to manufacture and functions in the same way as the first preferred embodiment.

Referring to FIG. 6, trimming a stock blind 22 can be easily simplified by the use of the container here disclosed. The manufacturer places the blind 22 in the clear, telescoping container 1. When the blind is being shipped and stored by the retailer it is best that the blind be kept within the container in a manner so that the blind will not move within the container during shipment and handling. Therefore, the container should have a length that is only slightly larger than the length of the blind. The retailer can store the blind on shelves that are accessible to customers. Making the container of clear plastic allows the customer and retailer to see the blind without removing the blind from its packaging. The customer can select the desired style and color of stock blind having dimensions closest to the dimensions of the window to be covered while not being smaller than that window. If the selected stock blind is larger than the required dimensions, the retailer can trim the blind without removing the blind from the container. When the blind is cut down an equal amount of material will be removed from both sides of the blind. The retailer will have a trimmer that can be used for this purpose. When blinds are purchased that require trimming to fit specific dimensions the end caps 18, 20 are removed. Next the inner section 4 and the outer section 2 are retracted to expose at least one end of the blind 22, as shown in FIG. 6. The exposed end of the blind is then trimmed. Next, the container is flipped and adjusted to expose the opposite end of the blind. That end is then trimmed. When the trimming process is completed the container can be expanded by telescoping the inner section 4 and the outer section 2 back out to its original size or a smaller size approximating the length of the cut down blind. Then the end caps are replaced. Since the container can be expanded to fully cover the blind, the end caps need not be fitted over any exposed portion of the blind. The flexible tabs 14, 16 prevent the container from expanding beyond its original size. The cut down blind 22 can be carried away from the trimming process without ever having to remove the blind from the container or repackage the blind 22. Consequently, the retailer can quickly and efficiently trim any stock blind to the dimensions required by the customer. It should be apparent from the drawings that the container could be in or return to its original size after the blind is cut down. Should that occur the blind could move back and forth inside the container. However, no damage is likely to occur because the blind will most likely be hand carried by the purchaser and not subjected to forces that might damage the blind.

The present preferred end cap shown in FIG. 7 has a cavity 24 that may be used to store hold down brackets or other hardware for the blind. After the hardware is placed within the cavity, a film or tape 25 may applied to the open end to secure the hardware within the cavity. Alternatively, the cavity could have a shape that conforms to the hardware being stored so that the hardware could be snap fit into the cavity. The ability to store the hardware in the end cap will assure that the hardware is not separated from the blind and misplaced during trimming. The common practice of placing hardware in one end of the blind, which hardware must be removed before the blind is trimmed, is also avoided.

The present container allows a blind to be shipped from the manufacturer, stored, trimmed and carried away from the retailer by the purchaser without removing the blind form the package. Although the container is particularly useful for venetian blinds, the container could be used for other types of other window coverings including vertical blinds, pleated and cellular shades, roll up shades and roller shades.

While the invention has been described in conjunction with specific embodiments thereof, the invention is not limited thereto, but may be variously embodied within the scope of the following claims.

We claim:

1. An adjustable telescoping window blind container comprising:
an outer tubular section having an interior surface, an exterior surface, a first open end, a second open end, and a flexible tab extending from said interior surface,
an inner tubular section, having an interior surface, an exterior surface, a first open end and a second open end, a portion of the inner tubular section being within the outer tubular section, the inner tubular section sized and configured to slide within the outer tubular section, the inner tubular section having a window aligned with the flexible tab in the outer tubular section and sized to receive the flexible tab and prevent the inner tubular section from being removed from the outer tubular section,
a first end cap removably attached to the first open end of the outer tubular section, and
and a second end cap removably attached to the second open end of the inner tubular section.

2. A container according to claim 1 wherein the container is constructed of plastic.

3. A container according to claim 1 wherein the container is constructed of clear plastic.

4. A container according to claim 1 wherein the tubular sections have a rectangular cross-section.

5. A container according to claim 1 wherein the tubular sections have a cross-section having a shape selected from the group of shapes consisting of circles, ovals, and polygons.

6. A container according to claim 1 wherein the container is sized to hold a venetian blind.

7. A container according to claim 1 also comprising a venetian blind within the container.

8. A container according to claim 1 also comprising a window covering within the container.

9. A container according to claim 1 wherein at least one of the end caps has a cavity sized to hold hardware for a blind.

10. A container according to claim 1 wherein at least one of the inner tubular section and the outer tubular section has a plurality of cuts, each cut defining a region that can be pushed inward to form a flexible tab.

11. A container according to claim 1 also comprising a second flexible tab extending from the inner tubular section.

12. A container according to claim 11 wherein the second flexible tab is adjacent the window.

13. An adjustable telescoping window blind container comprising:
an outer tubular section having an interior surface, an exterior surface, a first open end, a second open end, and a window,
an inner tubular section, having an interior surface, an exterior surface, a first open end and a second open end, a portion of the inner tubular section being within the outer tubular section, the inner tubular section sized and configured to slide within the outer tubular section, the inner tubular section having a flexible tab extending aligned with the window in the outer tubular section and sized to engage the window and prevent the inner tubular section from being removed from the outer tubular section,
a first end cap removably attached to the first open end of the outer tubular section, and
and a second end cap removably attached to the second open end of the inner tubular section.

14. A container according to claim 13 wherein the container is constructed of plastic.

15. A container according to claim 13 wherein the container is constructed of clear plastic.

16. A container according to claim 13 wherein the tubular sections have a rectangular cross-section.

17. A container according to claim 13 wherein the tubular sections have a cross-section having a shape selected from the group of shapes consisting of circles, ovals, and polygons.

18. A container according to claim 13 wherein the container is sized to hold a venetian blind.

19. A container according to claim 13 also comprising a venetian blind within the container.

20. A container according to claim 13 also comprising a window covering within the container.

21. A container according to claim 13 wherein at least one of the end caps has a cavity sized to hold hardware for a blind

22. A container according to claim 13 wherein at least one of the inner tubular section and the outer tubular section has a plurality of cuts, each cut defining a region that can be pushed inward to form a flexible tab.

23. A window blind and adjustable telescoping window blind container comprising:
a window blind,
an outer tubular section having an interior surface, an exterior surface, a first open end and a second open end, the outer tubular section covering at least a portion of the window blind,
an inner tubular section having an interior surface, an exterior surface, a first open end and a second open end, the inner tubular section covering at least a second portion of the window blind, a portion of the inner tubular section being within the outer tubular section, the inner tubular section sized and configured to slide within the outer tubular section, wherein the inner tubular section and the outer tubular section are sized to fully envelope the window blind when the inner tubular section and the outer tubular section are in a first position and to expose a portion of the window blind when the inner tubular section and the outer tubular section are telescoped to a second position,
a first end cap removably attached to the first open end of the outer tubular section, and
and a second end cap removably attached to the second open end of the inner tubular section.

24. A window blind and adjustable telescoping window blind container according to claim 23 wherein the inner tubular section and the outer tubular section are configured so that movement of the inner tubular section within the outer tubular section in a first direction will cause the sections to lock together preventing separation of the inner tubular section from the outer tubular section.

25. A window blind and adjustable telescoping window blind container according to claim 23 wherein the window blind is a venetian blind, vertical blind, pleated shade, cellular shade, roll up shade or roller shade.

26. A window blind and adjustable telescoping window blind container according to claim 23 wherein the container is constructed of clear plastic

27. A window blind and adjustable telescoping window blind container according to claim 23 wherein the tubular sections have a cross-section having a shape selected from the group of shapes consisting of circles, ovals, and polygons.

28. A window blind and adjustable telescoping window blind container according to claim 23 wherein at least one of the end caps has a cavity sized to hold hardware for a blind.

29. A method of trimming a venetian blind positioned within a container of the type having an outer tubular section having an interior surface, an exterior surface, a first open end and a second open end, an inner tubular section having an interior surface, an exterior surface, a first open end and a second open end, a portion of the inner tubular section being within the outer tubular section, the inner tubular section sized and configured to slide within the outer tubular section, a first end cap removably attached to the first open end of the outer tubular section, and a second end cap removably attached to the second open end of the inner tubular section, the method comprising:
a. removing at least one of the end caps from said container,
b. telescoping the container to a smaller size to expose at least one end of the blind,
c. trimming the at least one end of the blind,
d. exposing an opposite end of the blind,
e. trimming the opposite end of blind thereby forming a cut down blind,
f. telescoping the container to envelope the cut down blind, and
g. replacing the end caps onto the container.

30. A method according to claim 29 wherein the inner tubular section and the outer tubular section are configured so that movement of the inner tubular section within the outer tubular section in a first direction will cause the sections to lock together preventing separation of the inner tubular section from the outer tubular section.

31. A method according to claim 29 wherein the container also comprises a flexible tab extending from at least one of the inner tubular section and the outer tubular section, and wherein at least one of the inner tubular section and the outer tubular section have a window aligned with the flexible tab and sized to receive the flexible tab and prevent the inner tubular section from being removed from the outer tubular section.
